(19) United States
(12) Patent Application Publication
(10) Pub. No.: US 2026/0039318 A1
(43) Pub. Date: Feb. 5, 2026

(54) ELECTRONIC DEVICE AND METHOD FOR CONTROLLING ANTENNA

(71) Applicant: Samsung Electronics Co., Ltd., Suwon-si, Gyeonggi-do (KR)

(72) Inventors: Hyeongtae KIM, Suwon-si (KR); Hyunsoo KIM, Suwon-si (KR); Jongho PARK, Suwon-si (KR); Yongbeen YUN, Suwon-si (KR); Kijin JUNG, Suwon-si (KR)

(21) Appl. No.: 19/293,749

(22) Filed: Aug. 7, 2025

Related U.S. Application Data
(63) Continuation of application No. PCT/KR2025/011297, filed on Jul. 29, 2025.

(30) Foreign Application Priority Data
Aug. 5, 2024 (KR) 10-2024-0104020
Sep. 3, 2024 (KR) 10-2024-0118989

(51) Int. Cl. H04B 1/00; H01Q 5/50; H04W 72/02; H04W 88/06

(52) U.S. Cl. CPC H04B 1/0064; H01Q 5/50; H04W 72/02; H04W 88/06

(57) ABSTRACT

An electronic device may include: a communication circuit configured to transmit and receive a signal using at least one frequency, at least one antenna circuit comprising antennas and matching circuits, a memory configured to store instructions, and at least one processor, comprising processing circuitry, wherein at least one processor, individually and/or collectively, is configured to execute the instructions and to cause the electronic device to: identify a network frequency used by the electronic device, identify radio access technology (RAT) used by the electronic device, select control signals corresponding to passive gain information higher than or equal to a specified gain among a plurality of pieces of passive gain information corresponding to a plurality of control signals, based on the identified frequency and the identified RAT, sort and manage the selected control signals, measure each of an in-phase component (I) and a quadrature component (Q) by applying the selected control signals, and select a control signal corresponding to an IQ measurement value close to a reference value, based on the in-phase and quadrature components (IQ) measured through the application of the control signals.

### CROSS-REFERENCE TO RELATED APPLICATIONS

This application is a continuation of International Application No. PCT/KR2025/011297 designating the United States, filed on Jul. 29, 2025, in the Korean Intellectual Property Receiving Office and claiming priority to Korean Patent Application Nos. 10-2024-0104020, filed on Aug. 5, 2024, and 10-2024-0118989, filed on Sep. 3, 2024, in the Korean Intellectual Property Office, the disclosures of each of which are incorporated by reference herein in their entireties.

### BACKGROUND

### Field

The disclosure relates to an electronic device and an antenna control method.

### Description of Related Art

Recently, with the development of digital technologies, various electronic devices including mobile communication terminals, personal digital assistants (PDA), electronic organizers, smart phones, tablet personal computers (PC), and the like which can perform communication and process personal information while being carried have come to market.

As the thickness of the electronic device gradually decreases and the information display area of the display increases, a solid case is required. In order to secure the rigidity of the electronic device and increase the aesthetics of the appearance, the housing of the electronic device may be implemented using metal.

The electronic device tends to support radio frequency (RF) bands in various bands, and antenna techniques such as the metal frame segmentation structure using metal placed on the exterior as an antenna are used to support RF bands in various bands in a limited size of the electronic device.

When metal frames used as antennas included electronic devices are manufactured, manufacturing the metal frame, resonance frequencies of the antennas in the electronic devices may have deviation according to processing deviation.

The information may be provided as the related art to help in understanding of the disclosure. Any assertion or determination on whether the above-mentioned content can be applied as the prior art related to the disclosure has not been provided.

In general, in order to address deviation in a resonance frequency according to processing deviation of a metal frame used as an antenna in an electronic device, the deviation has been improved using an antenna tuner. However, it is difficult to improve the deviation in the resonance frequency only in a frequency band adjustable using the antenna tuner and a frequency band of a transmitted signal having a specific power level.

### SUMMARY

Embodiments of the disclosure provide an electronic device and an antenna control method that may generate a control signal for impedance matching of antennas that can cover various frequency bands and various power levels.

Embodiments of the disclosure provide an electronic device and an antenna control method that aims at improving the deviation of the signal generated by the processing deviation of an antenna, based on the control signal for impedance matching of the antenna.

An electronic device according to an example embodiment of the disclosure may include: a communication circuit configured to transmit and receive a signal using at least one frequency; at least one antenna circuit including antennas and matching circuits; a memory configured to store instructions; at least one processor, comprising processing circuitry; wherein at least one processor, individually or collectively, is configured to execute the instructions and to cause the electronic device to: identify a network frequency used by the electronic device; identify a radio access technology (RAT) used by the electronic device; select control signals corresponding to passive gain information higher than or equal to a specified gain among a plurality of pieces of passive gain information corresponding to a plurality of control signals, based on the identified frequency and the identified RAT; sort and manage the selected control signals; measure each in-phase component (I) and each quadrature component (Q) by applying the selected control signals; and based on the in-phase and quadrature components (IQ) measured by applying the control signals, select a control signal corresponding to an IQ measurement value within a specified value of a reference value.

A method of controlling antennas by an electronic device according to an example embodiment of the disclosure may include: identifying a network frequency used by the electronic device; identifying radio access technology (RAT) used by the electronic device; selecting control signals corresponding to passive gain information higher than or equal to a specified gain among a plurality of pieces of passive gain information corresponding to a plurality of control signals, based on the identified frequency and the identified RAT; sorting and managing the selected control signals; measuring each of an in-phase component (I) and a quadrature component (Q) by applying the selected control signals; and based on the in-phase and quadrature components (IQ) measured by applying the control signals, selecting a control signal corresponding to an IQ measurement value within a specified value of a reference value.

An electronic device and an antenna control method according to an example embodiment of the disclosure can improve the radio frequency (RF) performance of the electronic device by reducing deviation of a signal generated by processing deviation of an antenna, based on a control signal for impedance matching of the antenna.

An electronic device and an antenna control method according to an example embodiment of the disclosure can control signals of various frequency bands and various power levels without a separate tuner by reducing the deviation of the signal generated by the processing deviation of the antenna, based on the control signal for impedance matching of the antenna.

### BRIEF DESCRIPTION OF THE DRAWINGS

In connection with a description of drawings, the same or similar reference numerals may be used for the same or similar elements. Further, the above and other aspects, features and advantages of certain embodiments of the present disclosure will be more apparent from the following detailed description, taken in conjunction with the accompanying drawings, in which:

FIG. 1 is a block diagram illustrating an example configuration of an electronic device according to various embodiments;

FIG. 2 is a block diagram illustrating an example configuration of an electronic device for supporting legacy network communication and 5G network communication according to various embodiments;

FIG. 3 is a diagram illustrating an example structure of at least one antenna and a display of the electronic device according to various embodiments;

FIG. 4 is a block diagram illustrating an example configuration of an electronic device according to various embodiments;

FIG. 5 is a flowchart illustrating an example antenna control method of the electronic device according to various embodiments;

FIG. 6 is a diagram illustrating an example passive gain table stored in a memory according to various embodiments;

FIG. 7 is a diagram illustrating an example operation in which the electronic device sorts selected passive gain information according to various embodiments;

FIG. 8 is a diagram illustrating an example process of selecting passive gain information having in-phase and quadrature components closest to the standard impedance among classified passive gain information according to various embodiments; and

FIG. 9 is a diagram illustrating an example process of determining whether a change in in-phase and quadrature components (IQ) of selected passive gain information is made by a configured value or more according to various embodiments.

### DETAILED DESCRIPTION

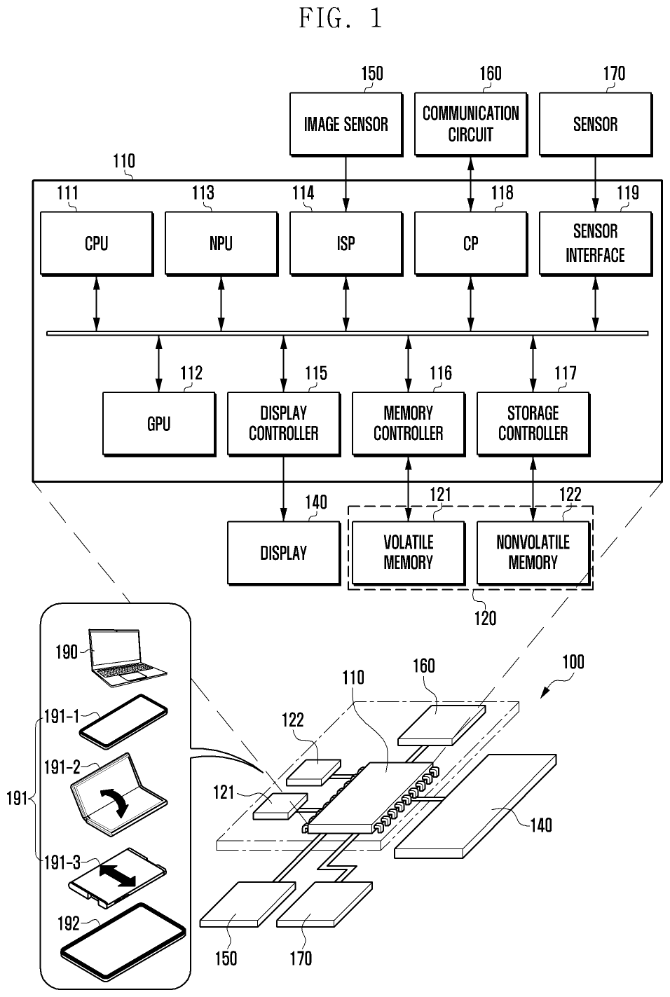

FIG. 1 is a block diagram illustrating an example configuration of an electronic device 100 capable of performing the operations described herein according to various embodiments.

Referring to FIG. 1, the electronic device 100 may be one of various types of electronic devices, such as a notebook computer 190, smartphones 191 having various form factors (e.g., a bar-type smartphone 191-1, a foldable smartphone 191-2, or a slidable (or rollable) smartphone 191-3), a tablet PC 192, a cellular telephone (not shown), and any other similar computing devices (not shown). The components illustrated in FIG. 1, the relationships thereof, and the functions thereof are merely for illustration, and are not intended to limit the implementations described or claimed in the disclosure thereto. The electronic device 100 may be referred to as a mobile device, a user equipment, a multifunctional device, a portable device, or a server.

The electronic device 100 may comprise various components including at least one processor (e.g., including processing circuitry) 110 (hereinafter, the processor 110), at least one memory 120 (hereinafter, the memory 120), at least one display 140 (hereinafter, the display 140), at least one image sensor 150 (hereinafter, the image sensor 150), at least one communication circuitry 160 (hereinafter, the communication circuitry 160), and/or at least one sensor 170 (hereinafter, the sensor 170). The aforementioned components are merely an example. For example, the electronic device 100 may comprise other components (e.g., a power management integrated circuitry (PMIC), an audio processing circuitry, an antenna, a rechargeable battery, or an input/output interface). For example, some components may be omitted from the electronic device (100). For example, some components may be integrated into one component.

The processor 110 may be implemented as one or more integrated circuit (or circuitry) (IC) chips and may perform various data processing. The processor 110 may include at least one electrical circuitry and may process instructions (or program, data, and so on) stored in the memory 120 individually or collectively in a distributed manner. The processor 110 may include a processor assembly that includes one or more processing circuitries. The processor may include any processing circuitry that may be operative for controlling operations and performance of one or more components (e.g., the memory 120, a display 140, the image sensor 150, the communication circuitry 160, and/or the sensor 170) of the electronic device. For example, the processor 110 (e.g., an application processor (AP)) may be implemented as a system on chip (SoC) (e.g., one chip or chipset). For example, the processor 110 may be implemented as a plurality of cores (or at least one core circuitry), a plurality of chips, or a plurality of chipsets. For example, the processor 110 may comprise one or more processing circuitry. For example, the processor 110 may comprise one or more processing circuitry which are individually and/or collectively configured to perform various functions of the present disclosure. As a non-limiting example, at least a portion of the processor 110 may be included in a first chip of the electronic device 100 and at least another portion of the processor 110 may be included in a second chip of the electronic device 100 different from the first chip of the electronic device 100.

For example, the processor 110 may comprise a central processing unit (CPU) 111, a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. These components of the processor 110 are merely of an example. For example, the processor 110 may further comprise other components. For example, some components of the processor 110 may be omitted from the processor 110. For example, some components of the processor 110 may be included as separate components of the electronic device 100 outside the processor 110. For example, some components of the processor 110 (e.g., the memory controller 116) may be included in other components of the electronic device 100 (e.g., at least a portion of the memory 120, an interface (e.g., usable for connecting to at least one component of the electronic device 100), the display 140, and/or the image sensor 150).

The processor 110 may cause other components of the electronic device 100 to perform various operations by executing instructions stored in the memory 120. The CPU 111 (or a central processing circuitry) may be configured to control the components of the processor 110 based on execution of instructions stored in the memory 120 (e.g., the volatile memory 121 and/or the non-volatile memory 122). The GPU 112 (or a graphic processing circuitry) may be configured to execute parallel computations (e.g., rendering). The NPU 113 (or a neural processing circuitry, or an artificial intelligence (AI) chip) may be configured to execute operations (e.g., convolution computations) for an artificial intelligence model. The ISP 114 (or an image signal processing circuitry) may be configured to process a raw image obtained from the image sensor 150 in a format suitable for a component in the electronic device 100 or a component of the processor 110. The display controller 115 (or a display control circuitry, or a display processing unit (DPU)) may be configured to process an image obtained from the CPU 111, the GPU 112, the ISP 114, or the memory 120 (e.g., the volatile memory 121) in a format suitable for the display 140. The memory controller 116 (or a memory control circuitry) may be configured to control reading data from the volatile memory 121 and writing data to the volatile memory 121. The storage controller 117 (or a storage control circuitry) may be configured to control reading data from the non-volatile memory 122 and writing data to the non-volatile memory 122. The CP 118 (or a communication processing circuitry) may be configured to process data obtained from a component of the processor 110 in a format suitable for transmission to another electronic device via the communication circuitry 160, or to process data obtained from another electronic device via the communication circuitry 160 in a format suitable for processing of the component of the processor 110. For example, the communication circuitry 160 may comprise one or more communication circuitry. The sensor interface 119 (or a sensing data processing circuitry, a sensor hub) may be configured to process data on a state of the electronic device 100 and/or a state around the electronic device 100, obtained through the sensor 170, in a format suitable for a component of the processor 110. Thus, the processor 110 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 120 may comprise one or more storage mediums (or one or more storage devices). For example, the memory 120 may include a memory assembly that includes one or more storage mediums. For example, the one or more storage mediums may comprise a permanent memory (e.g., the non-volatile memory 122) such as a hard drive, a flash memory, a read-only memory (ROM), a semi-permanent memory (e.g., the volatile memory 121) such as a random access memory (RAM), a storage (or a storage assembly) of any other suitable type, or any combination thereof. The memory 120 may comprise a cache memory which is a memory of one or more different types used to store data for performing a function or feature of the electronic device 100 at least temporarily. As a non-limiting example, the cache memory may be included in the processor 110. The memory 120 may be fixedly embedded within the electronic device 100, or may be incorporated onto one or more suitable types of components that may be repeatedly inserted into the electronic device 100, and removed from the electronic device 100 (e.g., a subscriber identity module (SIM) card, and/or a secure digital (SD) card).

For example, the memory 120 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 110. For example, the memory 120 may store instructions callable by an application programming interface (API). For example, the memory 120 may store instructions in a library.

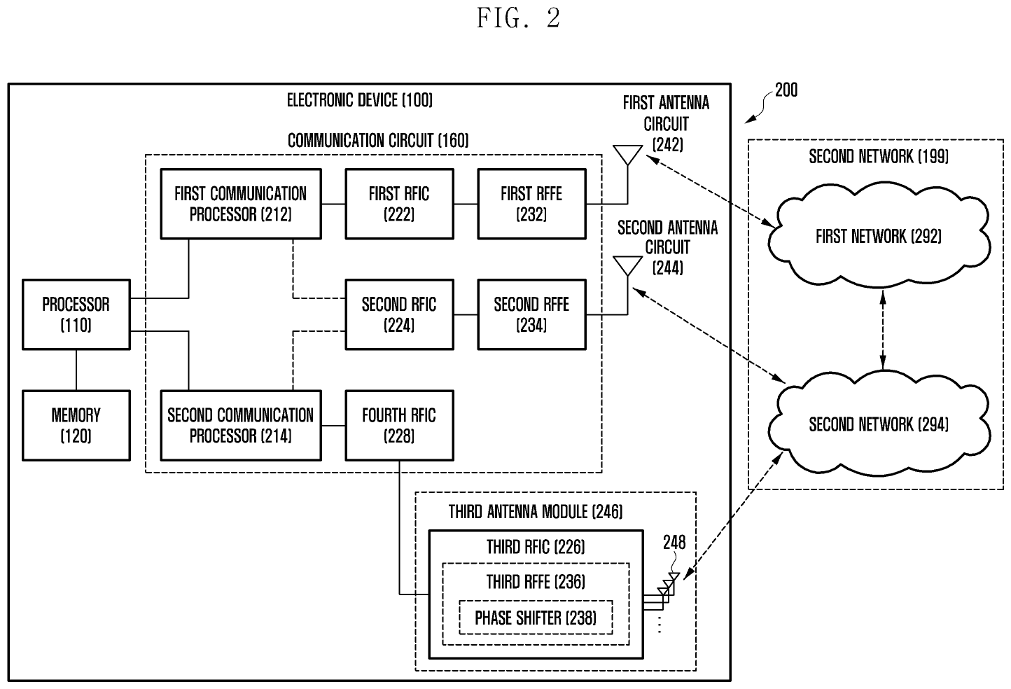

FIG. 2 is a block diagram 200 illustrating an example configuration of the electronic device 100 for supporting legacy network communication and 5G network communication according to various embodiments.

Referring to FIG. 2, the electronic device 100 may include a first communication processor (e.g., including processing circuitry) 212, a second communication processor (e.g., including processing circuitry) 214, a first radio frequency integrated circuit (RFIC) 222, a second RFIC 224, a third RFIC 226, a fourth RFIC 228, a first radio frequency front end (RFFE) 232, a second RFFE 234, a first antenna circuit 242, a second antenna module (e.g., including at least one antenna) 244, and antennas 248.

In an embodiment, the electronic device 100 may further include the processor 110 and the memory 120. The network 199 may include a first network 292 and a second network 294.

In an embodiment, the electronic device 100 may further include at least one component among the components illustrated in FIG. 1, and the network 199 may further include at least one other network.

In an embodiment, the first communication processor 212, the second communication processor 214, the first RFIC 222, the second RFIC 224, the fourth RFIC 228, the first RFFE 232, and/or the second RFFE 234 may configure at least a part of the communication circuit 160.

In an embodiment, the fourth RFIC 228 may be omitted or may be included as a part of the third RFIC 226.

In an embodiment, the CP 118 (communication processing circuit) of FIG. 1 may include the first communication processor 212 and/or the second communication processor 214.

In an embodiment, the first communication processor 212 may include various processing circuitry and establish a communication channel in a band to be used for wireless communication with the first network 292 and support legacy network communication through the established communication channel. The first communication processor 212 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment, the first network 292 may be a legacy network including a 2^{th}-generation (2G), 3G, 4G, or long-term evolution (LTE) network. The second communication processor 214 may include various processing circuitry and establish a communication channel corresponding to a predetermined band (for example, about 6 GHz to about 60 GHz) among bands to be used for wireless communication with the second network 294 and support 5G network communication through the established communication channel. The second communication processor 214 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment, the second network 294 may be a 5G network defined in the 3GPP.

In an embodiment, the first communication processor 212 and/or the second communication processor 214 may establish a communication channel corresponding to another predetermined band (for example, equal to or lower than about 6 GHZ) among the bands to be used for wireless communication with the second network 294 and support 5G network communication through the established communication channel.

In an embodiment, the first communication processor 212 and the second communication processor 214 may be implemented within a single chip or a single package.

In an embodiment, the first communication processor 212 and/or the second communication processor 214 may be configured with the processor 110, the CP 118 (communication processing circuit), or the communication circuit 160, within a single chip or a single package.

In an embodiment, in transmission, the first RFIC 222 may convert a baseband signal generated by the first communication processor 212 into a radio frequency (RF) signal from about 700 MHz to about 3 GHz used for the first network 292 (for example, legacy network). In reception, the RF signal may be acquired from the first network 292 (for example, legacy network) through an antenna (for example, the first antenna module 242) and may be preprocessed through the RFFE (for example, first RFFE 232). The first RFIC 222 may convert the preprocessed RF signal into a baseband signal to be processed by the first communication processor 212.

In an embodiment, in transmission, the second RFIC 224 may convert a baseband signal generated by the first communication processor 212 or the second communication processor 214 into an RF signal (hereinafter, referred to as a 5G Sub6 RF signal) in a Sub6 band (for example, equal to or lower than about 6 GHZ) used by the second network 294 (for example, the 5G network). In reception, a 5G Sub6 RF signal may be acquired from the second network 294 (for example, the 5G network) through an antenna (for example, the second antenna module 244) and may be preprocessed through the RFFE (for example, the second RFFE 234). The second RFIC 224 may convert the preprocessed 5G Sub6 RF signal into a baseband signal to be processed by the corresponding communication processor among the first communication processor 212 or the second communication processor 214.

In an embodiment, the third RFIC 226 may convert a baseband signal generated by the second communication processor 214 into an RF signal (hereinafter, referred to as a 5G Above6 RF signal) in a 5G Above6 band (for example, from about 6 GHz to about 60 GHz) used by the second network 294 (for example, the 5G network). In reception, a 5G Above6 RF signal may be acquired from the second network 294 (for example, 5G network) through an antenna (for example, the antenna 248) and may be preprocessed through the third RFFE 236. The third RFIC 226 may convert the preprocessed 5G Above6 RF signal into a baseband signal to be processed by the second communication processor 214. According to an embodiment, the third RFFE 236 may be configured as a part of the third RFIC 226.

In an embodiment, the electronic device 100 may include the fourth RFIC 228 separately from or as a part of the first RFIC 222, the second RFIC 224, or the third RFFIC 226.

In an embodiment, after converting a baseband signal generated by the second communication processor 214 into an RF signal (hereinafter, referred to as an IF signal) in an intermediate frequency band (for example, about 9 GHz to about 11 GHz), the fourth RFIC 228 may transfer the IF signal to the third RFIC 226. The third RFIC 226 may convert the IF signal into a 5G Above6 RF signal. In reception, a 5G Above6 RF signal may be received from the second network 294 (for example, the 5G network) through an antenna (for example, the antenna 248) and converted into an IF signal by the third RFIC 226. The fourth RFIC 228 may convert the IF signal into a baseband signal to be processed by the second communication processor 214.

In an embodiment, the first RFIC 222 and the second RFIC 224 may be implemented as a part of a single chip or a single package.

In an embodiment, the first RFFE 232 may be implemented with the second RFFE 234 as at least a part of a signal chip or a single package.

In an embodiment, at least one antenna circuit of the first antenna circuit 242 and/or the second antenna circuit 244 may be omitted or may be combined with another antenna to process RF signals in a plurality of corresponding bands.

For example, the first antenna circuit 242 and/or the second antenna circuit 244 may include one or more antennas. However, they are not limited thereto, and the first antenna circuit 242 may include one or more antennas and a matching circuit for impedance matching of the antennas. The second antenna circuit 244 may include one or more antennas and a matching circuit for impedance matching of the antennas.

In an embodiment, the third RFIC 226 and the antennas 248 may be placed on the same substrate and may configure the third antenna module 246. For example, the communication circuit 160 or the processor 110 may be placed on a first substrate (for example, a main PCB).

In an embodiment, the third RFIC 226 may be placed in a partial area (for example, bottom side) of a second substrate (for example, a sub PCB) separated from the first substrate and the antenna 248 may be disposed in another partial area (for example, top side) to configure the third antenna module 246. By placing the third RFIC 226 and the antennas 248 on the same substrate, it is possible to reduce the length of a transmission line therebetween. For example, it is possible to reduce loss of a signal in a high-frequency band (for example, about 6 GHz to about 60 GHz) used for 5G network communication by the transmission line. Accordingly, the electronic device 100 may improve quality or speed of communication with the second network 294 (for example, 5G network).

In an embodiment, the antennas 248 may be configured as an antenna array including a plurality of antenna elements that can be used for beamforming. In this case, the third RFIC 226 may include, for example, a plurality of phase shifters 238 corresponding to the plurality of antenna elements as a part of the third RFFE 236. In transmission, each of the plurality of phase shifters 238 may convert a phase of a 5G Above6 RF signal to be transmitted to the outside of the electronic device 100 (for example, a base station of the 5G network) through a corresponding antenna element. In reception, each of the plurality of phase shifters 238 may convert the phase of the 5G Above6 RF signal received from the outside through the corresponding antenna element into the same phase or substantially the same phase. This enables transmission or reception through beamforming between the electronic device 100 and the outside.

In an embodiment, the second network 294 (for example, the 5G network) may operate independently from the first network 292 (for example, the legacy network) (for example, stand-alone (SA)) or may operate through a connection thereto (for example, non-standalone (NSA)). For example, in the 5G network, only an access network (for example, a 5G radio access network (RAN) or a next generation RAN (NG RAN)) may exist without a core network (for example, a next generation core (NGC)). After accessing the access network of the 5G network, the electronic device 100 may access an external network (for example, Internet) according to the control of the core network (for example, evolved packed core (EPC)) of the legacy network. Protocol information (for example, LTE protocol information) for communication with the legacy network or protocol information (for example, new radio (NR) protocol information) for communication with the 5G network may be stored in the memory 230 and may be accessed by another component (for example, the processor 110, the first communication processor 212, or the second communication processor 214).

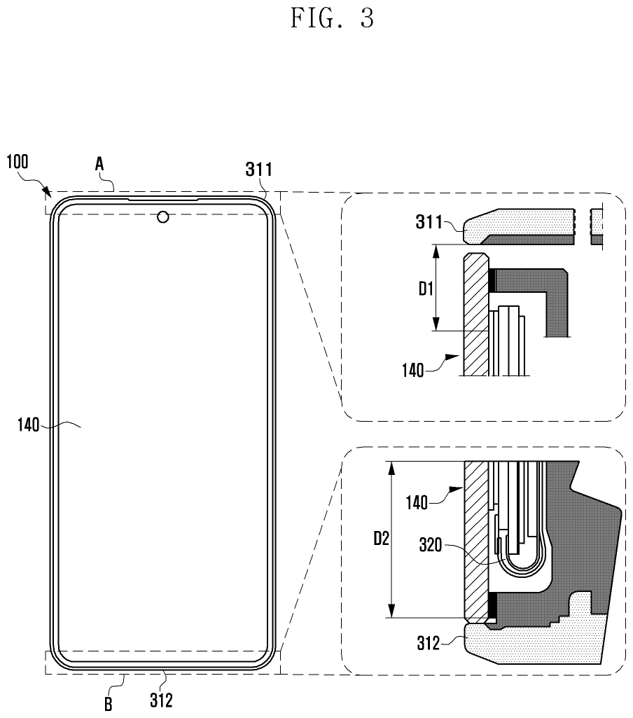

FIG. 3 is a diagram illustrating an example structure of at least one antenna 311 and 312 and the display 140 of the electronic device 100 according to various embodiments.

In an embodiment, the electronic device 100 may include the display 140 and at least one antenna 311 and 312.

In an embodiment, the first antenna 311 may be placed on the upper end (A) of the housing of the electronic device 100.

In an embodiment, the second antenna 312 may be placed on the lower end (B) of the housing of the electronic device 100.

In an embodiment, the first antenna 311 and/or the second antenna 312 may configure at least a part of the housing of the electronic device 100. The first antenna 311 and/or the second antenna 312 may comprise an exterior of the electronic device 100 and may include a segment structure. The first antenna 311 and/or the second antenna 312 may include metal or a metal frame. The first antenna 311 and/or the second antenna 312 including metal or the metal frame may influence the resonance frequency of the antenna due to deviation during processing.

In an embodiment, referring to the upper end (A), the display 140 may include a first black matrix (BM) area (D1).

In an embodiment, referring to the lower end (B), the display 140 may include a second BM area (D2). The lower end (B) of the housing may include a flexible printed circuit board (FPCB) 320 of the display 140. The BM area is an area in which the screen is not display on the display 140, and when the size of the BM area is small, the area of the screen that can be displayed is widened, which may be convenient for the user. When the size of the BM area is reduced, the FPCB 320 may approach the antenna (for example, the second antenna 312), thereby influencing the resonance frequency of the antenna.

The electronic device (for example, the electronic device 100) may have deviation in the resonance frequency by processing deviation of antennas (for example, the first antenna 311 and the second antenna 312) or approaching of an external object to electronic components (for example, the display 140) adjacent to antennas (for example, the first antenna 311 and the second antenna 312) and/or the antennas (for example, the first antenna 311 and the second antenna 312).

The electronic device 100 according to an embodiment of the disclosure may select and sort passive gain information on the antenna (for example, the first antenna 311 and the second antenna 312) according to the used frequency and radio access technology (RAT) to control the impedance of the antenna (for example, the first antenna 311 and the second antenna 312), thereby reducing the deviation in the resonance frequency by the processing deviation of the antenna (for example, the first antenna 311 and the second antenna 312), electronic components (for example, the display 140) adjacent to the antenna (e.g., the first antenna 311 and the second antenna 312), and/or approaching of an external object to an antenna (for example, the first antenna 311 and the second antenna 312) without a separate additional device.

The electronic device 100 according to an embodiment of the disclosure may include at least one processor 110 and the memory 120 configured to store instructions.

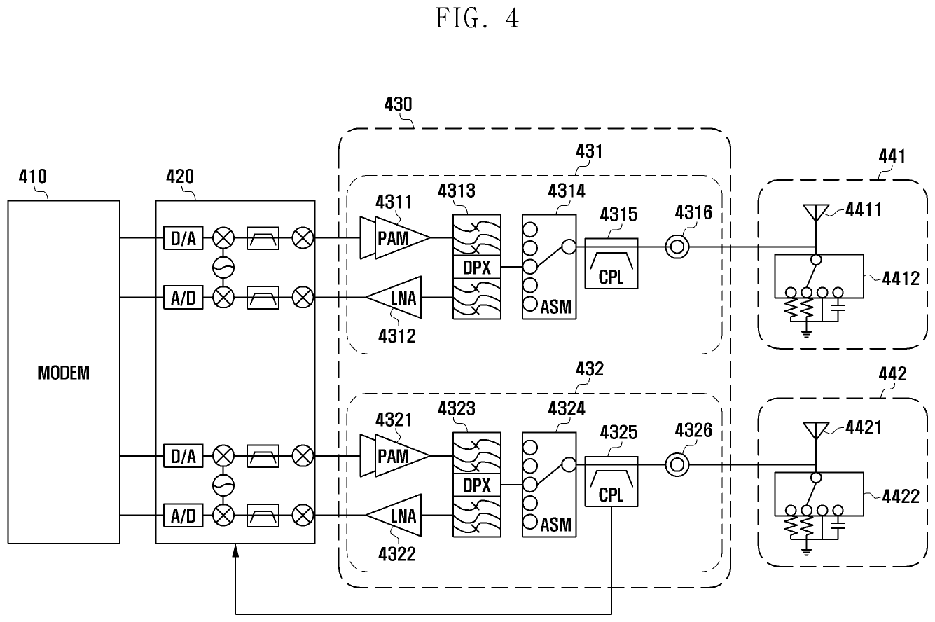

FIG. 4 is a block diagram illustrating an example configuration of the electronic device 100 according to various embodiments.

In an embodiment, the electronic device 100 may include a modem 410, a transceiver 420, antenna-based communication circuitry 430, a first antenna circuit 441, and a second antenna circuit 442.

In an embodiment, the memory 120 may store instructions. The instructions stored in the memory 120, when executed by at least one processor 110, may cause the electronic device 100 to, perform the control operation of the modem 410, the transceiver 420, the antenna-based communication circuitry 430, and/or the first antenna circuit 441 and the second antenna circuit 442.

In an embodiment, the modem 410 may convert and/or generate a band used for wireless communication into a baseband by at least one processor 110. The modem 410 may be implemented within a single chip or a single package. The modem 410 may be configured with the processor 110, the modem 410 and/or the communication circuit 430 within a single chip or a single package.

In an embodiment, the transceiver 420 may establish a communication channel in a band to be used for wireless communication and support network communication through the established communication channel.

According to an embodiment, the transceiver 420 may be implemented within a single chip or a single package.

In an embodiment, the transceiver 420 may be configured with the processor 110, the modem 410, an/or the communication circuit 430 within a single chip or a single package.

In an embodiment, when the electronic device 100 transmits a communication signal, the transceiver 420 may convert a baseband signal generated by the modem 410 into a radio frequency (RF) signal.

In an embodiment, the transceiver 420 may convert a radio frequency (RF) signal preprocessed by the antenna-based communication circuitry 430 into a baseband signal.

In an embodiment, when the electronic device 100 receives a communication signal, the radio frequency (RF) signal may be preprocessed by the antenna-based communication circuitry 430.

In an embodiment, the antenna-based communication circuitry 430 may include first antenna-based communication circuitry 431 and second antenna-based communication circuitry 432.

In an embodiment, the first antenna-based communication circuitry 431 may include a first power amplifier (PAM) 4311, a first low-noise amplifier (LNA) 4312, a first duplexer 4313, a first antenna switch module (ASM) 4314, a first coupler 4315, and a first radio frequency (RF) switch 4316.

In an embodiment, the first power amplifier 4311 may amplify a signal output by the transceiver 420 and transfer the signal to the first duplexer 4313. The first low-noise amplifier 4312 may amplify a signal output by the first duplexer 4313 and transfer the signal to the transceiver 420.

In an embodiment, the first duplexer 4313 may transfer a signal output by the first power amplifier 4311 and transfer the signal to the first antenna switch module 4314 or transfer a signal output by the first antenna switch module 4314 to the first low-noise amplifier 4312.

In an embodiment, the first antenna switch module 4314 may transfer a signal output by the first duplexer 4313 to the first coupler 4315 or transfer a signal output by the first coupler 4315 to the first duplexer 4313.

In an embodiment, the first coupler 4315 may transfer a signal to the first RF switch 4316 or transfer a signal received from the first RF switch 4316 to the first antenna switch module 4314.

In an embodiment, the second antenna-based communication circuitry 432 may include a second power amplifier 4321, a second low-noise amplifier 4322, a second duplexer 4323, a second antenna switch module 4324, a second coupler 4325, and a second RF switch 4326.

In an embodiment, the second power amplifier 4321 may amplify a signal output by the transceiver 420 and transfer the signal to the second duplexer 4323. The second low-noise amplifier 4322 may amplify a signal output by the second duplexer 4313 and transfer the signal to the transceiver 420.

In an embodiment, the second duplexer 4323 may transfer a signal output by the second power amplifier 4311 and transfer the signal to the second antenna switch module 4321 or transfer a signal output by the second antenna switch module 4314 to the second low-noise amplifier 4324.

In an embodiment, the second antenna switch module 4324 may transfer a signal output by the second duplexer 4313 to the second coupler 4323 or transfer a signal output by the second coupler 4315 to the second duplexer 4325.

In an embodiment, the second coupler 4325 may transfer a signal to the second RF switch 4316 or transfer a signal received from the second RF switch 4326 to the second antenna switch module 4314.

In an embodiment, the first coupler 4315 may distribute at least a portion of the incident signal and the reflection signal of the signal (for example, a transmission signal (Tx) output by the first antenna-based communication circuitry 431 and transfer the same to the transceiver 420.

In an embodiment, the second coupler 4325 may distribute at least a portion of the incident signal and the reflection signal of the signal (for example, a transmission signal (Tx) output by the second antenna-based communication circuitry 432 and transfer the same to the transceiver 420.

In an embodiment, the electronic device 100 may perform a feedback receiver (RBRX) function using at least one coupler (for example, the first coupler 4315 or the second coupler 4325) and/or the transceiver 420.

In an embodiment, the electronic device 100 may measure in-phase and quadrature components of the signal transmitted by the antenna-based communication circuitry 430 or the electronic device 100 through the feedback receiver (FBRX) function.

In an embodiment, the electronic device 100 may support radio access technology (RAT) such as standalone (SA), non-standalone (NSA), and/or carrier aggregation (CA).

In an embodiment, when the electronic device 100 performs a carrier aggregation (CA) operation, the instructions stored in the memory 120, when executed by at least one processor 110, may cause the electronic device 100 to, measure in-phase and quadrature components of the transmission signal from the antenna-based communication circuitry 430 or the electronic device 100, based on the transmission signal (Tx) of the primary component carrier (PCC) (for example, 4G communication frequency).

In an embodiment, when the electronic device 100 performs a non-standalone (NSA) operation, the instructions stored in the memory 120, when executed by at least one processor 110, may cause the electronic device 100 to, measure in-phase and quadrature components of the transmission signal from the antenna-based communication circuitry 430 or the electronic device 100, based on the transmission signal (Tx) of new radio (NR) (for example, 5G communication frequency).

In an embodiment, the first antenna-based communication circuitry 431 may include one or more LPAMID circuits, a front end module, a power amplifier, or a low-noise amplifier. The second antenna-based communication circuitry 220 may include one or more LPAMID circuits, a front end module, a power amplifier, or a low-noise amplifier.

In an embodiment, the LPAMID circuits may include a circuit in which a front end module, a power amplifier, and a low-noise amplifier are combined. The front end module may include a duplexer. The front end module may manage a signal path for filtering, matching, or switching a transmission and reception signal. The power amplifier may amplify a transmitted and received signal and transfer the signal to the antenna or the transceiver. The low-noise amplifier may amplify a reception signal and improve a signal-to-noise ratio.

In an embodiment, the antenna-based communication circuitry 430 may be implemented as at least a part of a signal chip or a single package.

In an embodiment, the antenna-based communication circuitry 430 may preprocess frequencies in a low band, a middle band, a high band, or an ultra-high band among communication channels used by the electronic device 100.

In an embodiment, the electronic device 100 may include s multi-transmission and reception system. The antenna-based communication circuitry 430 may combine and manage operations for transmission and reception in a wireless system.

In an embodiment, the antenna-based communication circuitry 430 may be electrically connected to the first antenna circuit 441. The first antenna-based communication circuitry 431 may be electrically connected to the first antenna circuit 441.

In an embodiment, the antenna-based communication circuitry 430 may transmit transmission signals through the first antenna circuit 441. The first antenna-based communication circuitry 431 may transmit transmission signals through the first antenna circuit 441. The first antenna-based communication circuitry 431 may receive reception signals through the first antenna circuit 441.

In an embodiment, the antenna-based communication circuitry 430 may be electrically connected to the second antenna circuit 442. The second antenna-based communication circuitry 432 may be electrically connected to the second antenna circuit 442.

In an embodiment, the antenna-based communication circuitry 430 may transmit transmission signals through the second antenna circuit 442. The second antenna-based communication circuitry 432 may transmit transmission signals through the second antenna circuit 442. The second antenna-based communication circuitry 432 may receive reception signals through the second antenna circuit 442.

In an embodiment, the first antenna circuit 441 may include a third antenna 4411 and a first matching circuit 4412. For example, the third antenna 4411 may include the first antenna 311 of FIG. 3.

In an embodiment, the second antenna circuit 442 may include a fourth antenna 4421 and a second matching circuit 4422. The fourth antenna 4421 may include the second antenna 312 of FIG. 3.

In an embodiment, the instructions stored in the memory 120, when executed by at least one processor 110, may cause the electronic device 100 to, change impedance matching of the third antenna 4411 by changing impedance of the first matching circuit 4412, based on selected passive gain information.

For example, the first matching circuit 4412 may make a change such that impedance corresponds to the selected passive gain information by opening or closing switches that connect the impedance and the third antenna 4411.

In an embodiment, the instructions stored in the memory 120, when executed by at least one processor 110, may cause the electronic device 100 to, change impedance matching of the fourth antenna 4421 by changing impedance of the second matching circuit 4422, based on selected passive gain information.

For example, the second matching circuit 4422 may make a change such that impedance corresponds to the selected passive gain information by opening or closing switches that connect the impedance and the third antenna 4411.

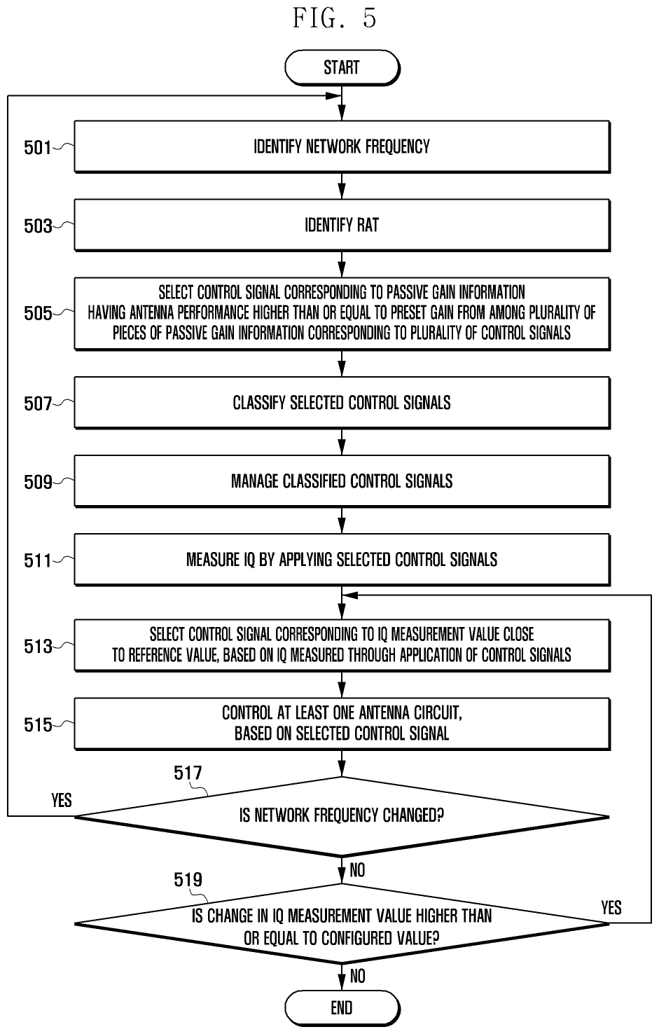

FIG. 5 is a flowchart illustrating an example antenna control method of the electronic device 100 according to various embodiments.

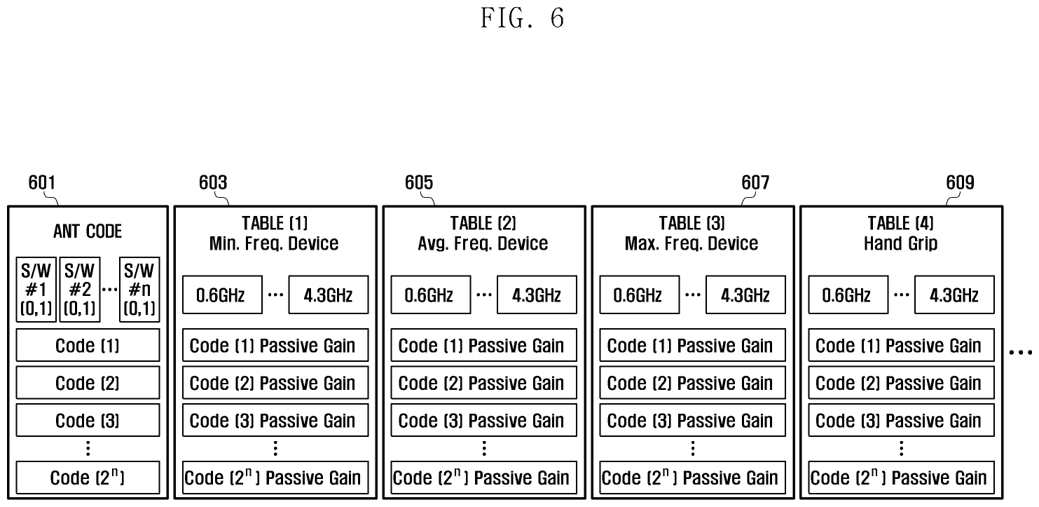

FIG. 6 is a diagram illustrating an example passive gain table stored in the memory 120 according to various embodiments.

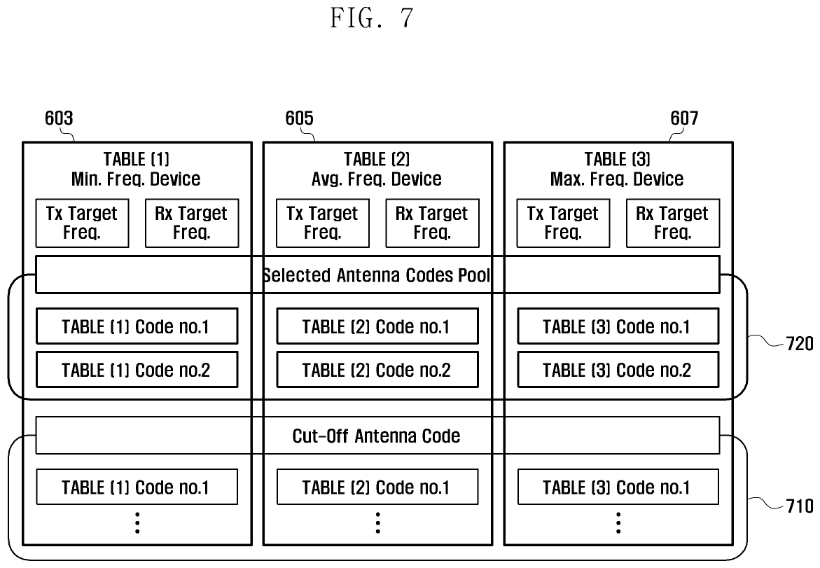

FIG. 7 is a diagram illustrating an example operation in which the electronic device 100 sorts selected passive gain information according to various embodiments.

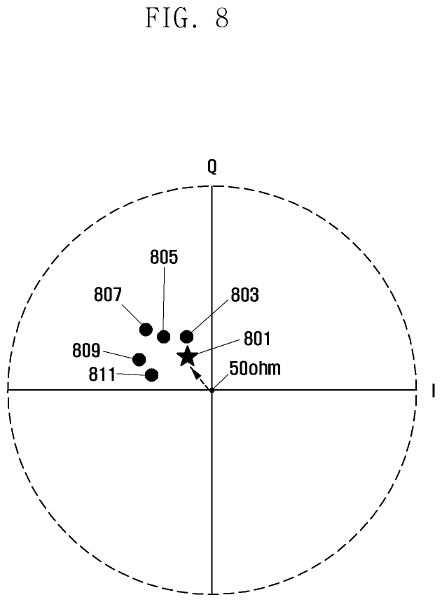

FIG. 8 is a diagram illustrating an example process of selecting passive gain information having in-phase and quadrature components closest to the standard impedance (for example, 50Ω) among classified passive gain information according to various embodiments.

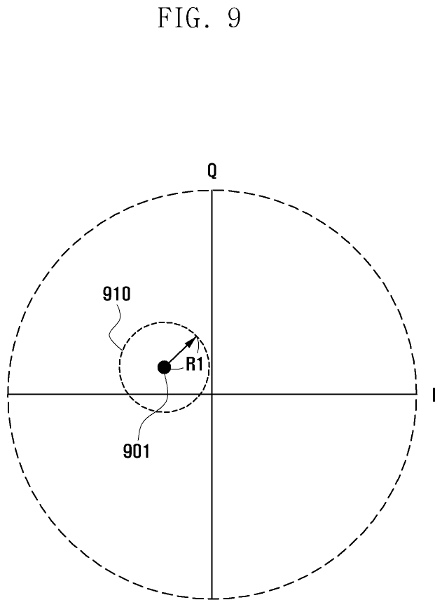

FIG. 9 is a diagram illustrating an example process of determining whether a change in in-phase and quadrature components (IQ) of selected passive gain information 910 is made by a configured value 910 or more according to various embodiments.

Referring to FIG. 5, in operation 501, the instructions stored in the memory 120, when executed by at least one processor 110, may cause the electronic device 100 to, identify a frequency of the network or a frequency band used by the electronic device 100.

In an embodiment, in operation 503, the instructions stored in the memory 120, when executed by at least one processor 110, may cause the electronic device 100 to, identify radio access technology (RAT) used by the electronic device 100.

In an embodiment, the electronic device 100 may support radio access technology (RAT) such as standalone (SA), non-standalone (NSA), and/or carrier aggregation (CA).

In an embodiment, the electronic device 100 may support radio access technology (RAT) such as not only standalone (SA), non-standalone (NSA), and/or carrier aggregation (CA) but also antenna switching (AS) or EN-DC.

In an embodiment, in operation 505, the instructions stored in the memory 120, when executed by at least one processor 110, may cause the electronic device 100 to, select passive gain information higher than or equal to a preset (e.g., specified) gain among a plurality of pieces of passive gain information.

In an embodiment, in operation 505, the instructions stored in the memory 120, when executed by at least one processor 110, may cause the electronic device 100 to, select passive gain information included in a plurality of passive gain tables stored in the memory 120, based on the identified frequency and radio access technology (RAT).

In an embodiment, in operation 505, the instructions stored in the memory 120, when executed by at least one processor 110, may cause the electronic device 100 to, cut off passive gain information lower than a preset gain among a plurality of pieces of passive gain information.

The passive gain table according to an embodiment of the disclosure may include information on a control signal corresponding to passive gain information.

In an embodiment, in operation 505, the instructions stored in the memory 120, when executed by at least one processor 110, may cause the electronic device 100 to, select control signals corresponding to passive gain information higher than or equal to a preset gain among a plurality of pieces of passive gain information corresponding to a plurality of control signals.

The electronic device 100 according to an embodiment of the disclosure may change a resonance frequency (or a natural frequency) of at least one antenna (for example, the third antenna 4411 or the fourth antenna 4421) by changing impedance matching between a matching circuit (for example, the first matching circuit 4412 or the second matching circuit 4422) and at least one antenna (for example, the third antenna 4411 or the fourth antenna 4421), based on control signals.

The passive gain table (or a plurality of pieces of passive gain information) according to an embodiment of the disclosure may include information on an antenna gain when the electronic device 100 is in a standalone (SA) state.

However, the disclosure is not limited thereto, and the passive gain table (or a plurality of pieces of passive gain information) may include information on an antenna gain when the electronic device 100 is in a non-standalone (NSA), carrier aggregation (CA), antenna switching (AS) and/or EN-DC state as well as the standalone (SA) state.

In an embodiment, at least one antenna (for example, the third antenna 4411 or the fourth antenna 4421) may be manufactured within an error range (for example, 0.5 mm) allowed during processing.

Referring to FIGS. 5 and 6, the passive gain table (or a plurality of pieces of passive gain information) may include a control signal table 601, a first antenna gain table 603, a second antenna gain table 605, a third gain table 605, and/or an antenna gain table 607 according to a hand grip state.

Referring to FIGS. 5 and 6, the first antenna gain table 603 may include a plurality of pieces of passive gain information for antennas (for example, the third antenna 4411 and the fourth antenna 4421) having a resonance frequency lower than the resonance frequency among antennas having processing deviation.

Referring to FIGS. 5 and 6, the second antenna gain table 605 may include a plurality of pieces of passive gain information for antennas (for example, the third antenna 4411 and the fourth antenna 4421) having an average resonance frequency among antennas having processing deviation.

Referring to FIGS. 5 and 6, the third antenna gain table 607 may include a plurality of pieces of passive gain information for antennas (for example, the third antenna 4411 and the fourth antenna 4421) having a resonance frequency higher than the resonance frequency among antennas having processing deviation.

Referring to FIGS. 5 and 6, the antenna gain table 609 according to the hand grip state may include a plurality of pieces of passive gain information for at least one antenna (for example, the third antenna 4411 and the fourth antenna 4421) in the hand grip state.

Referring to FIGS. 5 and 6, the control signal table 601 may include a plurality of control signals. The plurality of control signals may include signals for controlling a switch connected to impedance included in a matching circuit (for example, the first matching circuit 4412 or the second matching circuit 4422). Each of the plurality of control signals may correspond to each of information on antenna gains included in the antenna gain tables 603, 605, and 607.

In an embodiment, the electronic device 100 may store, in a lookup table (or the passive gain table), antenna gains (or passive gains) for all antennas within a processing tolerance range (for example, about 0.5 mm) of at least one antenna (for example, the third antenna 4411 or the fourth antenna 4421) in the memory 120.

In an embodiment, antenna gains (or passive gains) for all antennas within the processing tolerance range (for example, about 0.5 mm) of at least one antenna (for example, the third antenna 4411 or the fourth antenna 4421) may include an antenna gain according to a frequency band and/or radio access technology (RAT).

Referring to the first antenna gain table 603, the second antenna gain table 605, and the third antenna gain table 607 of FIG. 6, the passive gain table may include a plurality of pieces of passive gain information for each frequency band for all antennas within the processing tolerance range (for example, about 0.5 mm).

Referring to the antenna gain table 609 according to the hand grip state of FIG. 6, the passive gain table may include a plurality of pieces of passive gain information in the hand grip state for all antennas within the processing tolerance range (for example, about 0.5 mm).

In an embodiment, the passive gain table may include a plurality of pieces of passive gain information in an accessory-mounted state for all antennas within the processing tolerance range (for example, about 0.5 mm).

In an embodiment, the passive gain table may include antenna gains (or passive gains) for all antennas within the processing tolerance range (for example, about 0.5 mm) of at least one antenna (for example, the third antenna 4411 or the fourth antenna 4421) when a hand grip situation occurs in the electronic device 100 or accessory is mounted on the electronic device 100.

For example, the accessory may include a battery charging accessory of the electronic device 100 and an accessory associated with a protection cover.

In an embodiment, the electronic device 100 may include at least one sensor (for example, a hall sensor and a dielectric constant change detection sensor) for determining whether an accessory is mounted.

In an embodiment, when the electronic device 100 is a bar-type smartphone 191-1, the passive gain table may include antenna gains (or passive gains) for all antennas within the processing tolerance range (for example, about 0.5 mm) of at least one antenna (for example, the third antenna 4411 or the fourth antenna 4421).

In an embodiment, when the electronic device 100 is a foldable-type smartphone 191-2 or a slidable (or rollable)-type smartphone 191-3, the passive gain table may include antenna gains (or passive gains) for all antennas within the processing tolerance range (for example, about 0.5 mm) of at least one antenna (for example, the third antenna 4411 or the fourth antenna 4421) according to a housing state change (for example, folding, unfolding, insertion, or removal) of the electronic device 100.

In an embodiment, the electronic device 100 may include at least one sensor (for example, the hall sensor and the dielectric constant change detection sensor) for detecting the housing state change (for example, folding, unfolding, insertion, or removal) of the electronic device 100.

In an embodiment, in operation 507, the instructions stored in the memory 120, when executed by at least one processor 110, may cause the electronic device 100 to, sort (e.g., classify) selected control signals.

Referring to FIG. 5, in operation 507, the instructions stored in the memory 120, when executed by at least one processor 110, may cause the electronic device 100 to, sort (e.g., classify) selected passive gain information.

In an embodiment, in operation 507, the instructions stored in the memory 120, when executed by at least one processor 110, may cause the electronic device 100 to, identify a value of combined average of passive gain information and sort (e.g., classify) the same in descending order.

In an embodiment, in operation 507, the instructions stored in the memory 120, when executed by at least one processor 110, may cause the electronic device 100 to, add a weight according to radio access technology (RAT) used by the electronic device 100, identify a value of combined average of passive gain information, and sort (e.g., classify) the same in descending order.

In an embodiment, in operation 507, the instructions stored in the memory 120, when executed by at least one processor 110, may cause the electronic device 100 to, sort (e.g., classify) selected passive gain information.

In an embodiment, in operation 507, the instructions stored in the memory 120, when executed by at least one processor 110, may cause the electronic device 100 to, identify a value of the average of the sum of passive gain information and sort (e.g., classify) the same in descending order.

In an embodiment, in operation 507, the instructions stored in the memory 120, when executed by at least one processor 110, may cause the electronic device 100 to, add a weight according to radio access technology (RAT) used by the electronic device 100, identify a value of combined average of passive gain information, and sort (classify) the same in descending order.

For example, when the radio access technology (RAT) used by the electronic device 100 is CA and/or NSA, the weight may be further assigned to the passive gain information compared to the case where SA is used.

Referring to FIG. 5 and reference numeral 710 of FIG. 7, the instructions stored in the memory 120, when executed by at least one processor 110, may cause the electronic device 100 to, cut off passive gain information lower than a preset gain among a plurality of pieces of passive gain information.

Referring to FIG. 5 and reference numeral 720 of FIG. 7, the instructions stored in the memory 120, when executed by at least one processor 110, may cause the electronic device 100 to, identify a value of combined average of selected passive gain information higher than or equal to a preset gain and sort the same in descending order.

TABLE 1

| | | | | First antenna | |
|---|---|---|---|---|---|
| | | Control signal included in | | gain table 603 | |
| | | control signal table 601 | | Antenna | Antenna |
| | | First | Second | gain in | gain in |
| | | control | control | first | second |
| | | signal | Signal | frequency | frequency |
| Sorting | 1 | 0x1A00 | 0x07040F | −7.42 | −6.28 |
| order | 2 | 0x1A00 | 0x0F040F | −7.92 | −7.25 |

| | | | | |
|---|---|---|---|---|
| Cut-off passive | 0x1A00 | 0x05040F | −8.11 | −7.12 |
| gain information | 0x1600 | 0x05040F | −8.36 | −8.21 |

TABLE 2

| | | | | Third antenna | |
|---|---|---|---|---|---|
| | | Control signal included in | | gain table 607 | |
| | | control signal table 601 | | Antenna | Antenna |
| | | First | Second | gain in | gain in |
| | | control | control | first | second |
| | | signal | signal | frequency | frequency |
| Sorting | 1 | 0x1600 | 0x0F0500 | −7.58 | −7.06 |
| order | 2 | 0x1600 | 0x0F040F | −7.99 | −7.31 |

| | | | | |
|---|---|---|---|---|
| Cut-off passive | 0x1600 | 0x0F050F | −8.41 | −9.17 |
| gain information | 0x1A00 | 0x0F040F | −8.87 | −8.21 |

Table 1 and Table 2 are tables of selecting and sorting (e.g., classifying) passive gain information according to preset gains among a plurality of pieces of passive gain information by the electronic device 100 of the disclosure.

Referring to Table 1 and Table 2, the instructions stored in the memory 120, when executed by at least one processor 110, may cause the electronic device 100 to, identify a value of combined average of selected passive gain information higher than or equal to a preset gain and sort (e.g., classify) the same in descending order.

In an embodiment, in operation 509, the instructions stored in the memory 120, when executed by at least one processor 110, may cause the electronic device 100 to, manage selected or sorted (e.g., classified) control signals. For example, in an embodiment, in operation 509, the instructions stored in the memory 120, when executed by at least one processor 110, may cause the electronic device 100 to, store the selected or sorted (e.g., classified) control signal in the memory 120.

Referring to FIG. 5, in operation 509, the instructions stored in the memory 120, when executed by at least one processor 110, may cause the electronic device 100 to, manage the sorted (e.g., classified) passive gain information.

In an embodiment, in operation 509, the instructions stored in the memory 120, when executed by at least one processor 110, may cause the electronic device 100 to, store the sorted (e.g., classified) passive gain information in a separate table in the memory 120.

In an embodiment, in operation 509, the instructions stored in the memory 120, when executed by at least one processor 110, may cause the electronic device 100 to, manage the classified passive gain information.

In an embodiment, in operation 509, the instructions stored in the memory 120, when executed by at least one processor 110, may cause the electronic device 100 to, store the classified passive gain information in a separate table in the memory 120.

In an embodiment, in operation 511, the instructions stored in the memory 120, when executed by at least one processor 110, may cause the electronic device 100 to, measure each of in-phase and quadrature components by applying selected control signals.

In an embodiment, in operation 511, the instructions stored in the memory 120, when executed by at least one processor 110, may cause the electronic device 100 to, measure the in-phase and quadrature components for the sorted passive gain information.

In an embodiment, in operation 511, the instructions stored in the memory 120, when executed by at least one processor 110, may cause the electronic device 100 to, measure the in-phase and quadrature components for the classified passive gain information.

In an embodiment, in operation 513, the instructions stored in the memory 120, when executed by at least one processor 110, may cause the electronic device 100 to, select a control signal corresponding to an IQ measurement value close to a reference value (for example, 50Ω), based on the in-phase and quadrature components measured through the application of control signals.

In an embodiment, in operation 513, the instructions stored in the memory 120, when executed by at least one processor 110, may cause the electronic device 100 to, select passive gain information having in-phase and quadrature components close to the reference value (for example, 50Ω) among the sorted passive gain information.

In an embodiment, in operation 513, the instructions stored in the memory 120, when executed by at least one processor 110, may cause the electronic device 100 to, select passive gain information having in-phase and quadrature components closest to standard impedance (for example, 50Ω) among the sorted passive gain information.

In an embodiment, in operation 513, the instructions stored in the memory 120, when executed by at least one processor 110, may cause the electronic device 100 to, select passive gain information closest to standard impedance (for example, 50Ω), based on the identified in-phase and quadrature components, among the sorted passive gain information.

In an embodiment, in operation 513, the instructions stored in the memory 120, when executed by at least one processor 110, may cause the electronic device 100 to, select passive gain information having in-phase and quadrature components closest to the standard impedance (for example, 50Ω) among the classified passive gain information.

In an embodiment, in operation 513, the instructions stored in the memory 120, when executed by at least one processor 110, may cause the electronic device 100 to, select passive gain information closest to the standard impedance (for example, 50Ω), based on the identified in-phase and quadrature components, among the classified passive gain information.

Referring to FIG. 5 and an IQ chart of FIG. 8, the instructions stored in the memory 120, when executed by at least one processor 110, may cause the electronic device 100 to, select passive gain information 801 having in-phase and quadrature components close to the reference value (for example, 50Ω) among sorted passive gain information 801, 803, 805, 807, 809, and 811.

Referring to FIG. 5 and the IQ chart of FIG. 8, the instructions stored in the memory 120, when executed by at least one processor 110, may cause the electronic device 100 to, select the passive gain information 801 having in-phase and quadrature components closest to standard impedance (for example, 50Ω) among the classified passive gain information 801, 803, 805, 807, 809, and 811.

In an embodiment, in operation 515, the instructions stored in the memory 120, when executed by at least one processor 110, may cause the electronic device 100 to, control at least one antenna circuit (for example, the first antenna circuit 441 or the second antenna circuit 442), based on selected passive gain information (for example, 801 of FIG. 8).

In an embodiment, in operation 515, the instructions stored in the memory 120, when executed by at least one processor 110, may cause the electronic device 100 to, control at least one antenna circuit (for example, the first antenna circuit 441 or the second antenna circuit 442), based on a control signal (for example, the control signal table 601 of FIG. 6, the first control signal and/or the second control signal of [Table 1], or the first control signal and/or the second control signal of [Table 2]) corresponding to the selected passive gain information (for example, 801 of FIG. 8).

In an embodiment, in operation 515, the instructions stored in the memory 120, when executed by at least one processor 110, may cause the electronic device 100 to, change a resonance frequency (or a natural frequency) of at least one antenna circuit (for example, the first antenna circuit 441 or the second antenna circuit 442) by controlling switches connected to impedance in a matching circuit (for example, the first matching circuit 4412 or the second matching circuit 4422), based on a control signal (for example, the control signal table 601 of FIG. 6, the first control signal and/or the second control signal of [Table 1], or the first control signal and/or the second control signal of [Table 2]) corresponding to the selected passive gain information (for example, 801 of FIG. 8).

In an embodiment, in operation 517, the instructions stored in the memory 120, when executed by at least one processor 110, may cause the electronic device 100 to, determine whether a network frequency used by the electronic device 100 is changed.

When the network frequency used by the electronic device 100 is changed, the instructions stored in the memory 120, when executed by at least one processor 110, may cause the electronic device 100 to, proceed to operation 501 from operation 517.

When the network frequency used by the electronic device 100 is not changed, the instructions stored in the memory 120, when executed by at least one processor 110, may cause the electronic device 100 to, proceed to operation 519 from operation 517.

In an embodiment, in operation 519, the instructions stored in the memory 120, when executed by at least one processor 110, may cause the electronic device 100 to, determine whether a change in an in-phase and quadrature components (IQ) measurement value 901 of the selected control signal is made by a threshold (e.g., configured value) 910 or more. The threshold 910 may be configured to be spaced from the selected passive gain information 901 by a predetermined distance (r1) or longer.

Referring to FIGS. 5 and 9, in operation 519, the instructions stored in the memory 120, when executed by at least one processor 110, may cause the electronic device 100 to, determine whether the change in the in-phase and quadrature components (IQ) measurement value 901 is made by the threshold 910 or more. The threshold 910 may be configured to be spaced from the selected passive gain information 901 by a predetermined distance (r1) or longer.

In an embodiment, the IQ measurement value 901 may include a value obtained by measuring in-phase and quadrature components (IQ) of the passive gain information selected in operation 513.

In an embodiment, the instructions stored in the memory 120, when executed by at least one processor 110, may cause the electronic device 100 to, perform operation 519 on a predetermined cycle.

In an embodiment, when the change in the in-phase and quadrature components (IQ) measurement value 901 is made by the threshold 910 or more, the instructions stored in the memory 120, when executed by at least one processor 110, may cause the electronic device 100 to, proceed to operation 513 from operation 519.

In an example embodiment, an electronic device may include a communication circuit (for example, the communication circuit 160 or the communication circuit 430) configured to transmit and receive a signal using at least one frequency, at least one antenna circuit (for example, the third antenna 4411 or the fourth antenna 4421) including antennas and matching circuits (for example, the first matching circuit 4412 and the second matching circuit 4422), a memory configured to store instructions, and at least one processor, comprising processing circuitry, wherein at least one processor, individually and/or collectively, is configured to execute the instructions and to cause the electronic device to: identify a network frequency used by the electronic device, identify radio access technology (RAT) used by the electronic device, select control signals corresponding to passive gain information higher than or equal to a specified gain among a plurality of pieces of passive gain information corresponding to a plurality of control signals, based on the identified frequency and the identified RAT, sort (e.g., classify) and manage the selected control signals, measure each of an in-phase component (I) and a quadrature component (Q) by applying the selected control signals, and select a control signal corresponding to an IQ measurement value close to a reference value, based on the in-phase and quadrature components (IQ) measured through the application of the control signals.

In an example embodiment, at least one processor, individually and/or collectively, may be configured to cause the electronic device to, based on the selected control signal, match impedance of the antennas by controlling the at least one antenna circuit (for example, the third antenna 4411 or the fourth antenna 4421).

In an example embodiment, at least one processor, individually and/or collectively, may be configured to cause the electronic device to control the at least one antenna circuit, based on the selected control signal, to identify whether the network frequency is periodically changed while a communication operation is performed using the antennas with which the impedance matches.

In an example embodiment, at least one processor, individually and/or collectively, may be configured to cause the electronic device to identify whether a change in the in-phase and quadrature components (IQ) measurement value of the selected control signal is greater than or equal to a configured change based on the network frequency being maintained.

In an example embodiment, at least one processor, individually and/or collectively, may be configured to cause the electronic device to: based on the change in the in-phase and quadrature components (IO) measurement value of the selected control signal being larger than or equal to the configured change, measure IQ of an RF signal according to the classified control signals, identify an RF signal close to the reference value among the measured IQ and select again a control signal corresponding to the measured RF signal, and control the antenna circuit, based on the control signal selected again.

In an example embodiment, at least one processor, individually and/or collectively, may be configured to cause the electronic device to based on the network frequency being changed, select passive gain information, based on the changed frequency and RAT, and control the antenna circuit, based on the selected passive gain information.

In an example embodiment, each of the plurality of pieces of passive gain information may correspond to a signal of controlling at least one switch which connects impedance included in the matching circuit (for example, the first matching circuit 4412 or the second matching circuit 4422) with the antenna.

In an example embodiment, at least one processor, individually and/or collectively, may be configured to cause the electronic device to identify whether radio access technology (RAT) used by the electronic device is at least one of standalone (SA), non-standalone (NSA), and/or carrier aggregation.

In an example embodiment, at least one processor, individually and/or collectively, may be configured to cause the electronic device to store, in the memory, the plurality of pieces of passive gain information as a lookup table converted in a code format.

In an example embodiment, at least one processor, individually and/or collectively, may be configured to cause the electronic device to identify a value of combined average of passive gains of RF signals according to the selected control signals and sort the control signals in descending order.

In an example embodiment, a method of controlling antennas by an electronic device may include: identifying a network frequency used by the electronic device, identifying radio access technology (RAT) used by the electronic device, selecting control signals corresponding to passive gain information higher than or equal to a specified gain among a plurality of pieces of passive gain information corresponding to a plurality of control signals, based on the identified frequency and the identified RAT, sorting and managing the selected control signals, measuring each of an in-phase component (I) and a quadrature component (Q) by applying the selected control signals, and selecting a control signal corresponding to an IQ measurement value close to a reference value, based on the in-phase and quadrature components (IQ) measured through the application of the control signals.

In an example embodiment, the method of controlling antennas by the electronic device may further include controlling the at least one antenna circuit (for example, the third antenna 4411 or the fourth antenna 4421), based on the selected control signal.

In an example embodiment, the method of controlling antennas by the electronic device may further include identifying whether the network frequency is periodically changed while a communication operation is performed using the antennas with which the impedance matches.

In an example embodiment, the method of controlling antennas by the electronic device may further include identifying whether a change in the in-phase and quadrature components (IQ) measurement value of the selected control signal is larger than or equal to a configured change based on the network frequency being maintained.

In an example embodiment, the method of controlling antennas by the electronic device may include, based on the change in the in-phase and quadrature components (IO) measurement value of the selected control signal being larger than or equal to the configured change, measuring IQ of an RF signal according to the classified control signals, identifying an RF signal close to the standard impedance among the measured IQ and selecting again a control signal corresponding to the measured RF signal, and controlling the antenna circuit, based on the control signal selected again.

In an example embodiment, the method of controlling antennas by the electronic device may further include, based on the network frequency being changed, selecting passive gain information, based on the changed frequency and RAT, and controlling the antenna circuit, based on the selected passive gain information.

In an example embodiment, the method of controlling antennas by the electronic device may further include identifying whether radio access technology (RAT) used by the electronic device 100 is at least one of standalone (SA), non-standalone (NSA), and/or carrier aggregation.

In an example embodiment, the method of controlling antennas by the electronic device may further include storing, in the memory 120, the plurality of pieces of passive gain information as a lookup table converted in a code format.

In an example embodiment, the method of controlling antennas by the electronic device may further include identifying a value of combined average of passive gains of RF signals according to the selected passive gain information and sorting the passive gain information in descending order.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, a home appliance, or the like. The electronic device according to embodiments of the disclosure is not limited to those described above.

It should be appreciated that the various example embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), the element may be coupled/connected with/to the other element directly (e.g., wiredly), wirelessly, or via a third element.

As used in various embodiments of the disclosure, the term “module” may include a unit implemented in hardware, software, or firmware, or ay combination thereof, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software including one or more instructions that are stored in a storage medium that is readable by a machine (e.g., the electronic device 101). For example, a processor of the machine may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Herein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a communication circuit configured to transmit and receive a signal using at least one frequency;
at least one antenna circuit comprising antennas and matching circuits;
a memory configured to store instructions; and
at least one processor, comprising processing circuitry,
wherein at least one processor, individually and/or collectively, is configured to execute the instructions and to cause the electronic device to:
identify a network frequency used by the electronic device;
identify a radio access technology (RAT) used by the electronic device;
select control signals corresponding to passive gain information higher than or equal to a specified gain among a plurality of pieces of passive gain information corresponding to a plurality of control signals, based on the identified frequency and the identified RAT;
sort and manage the selected control signals;
measure each in-phase components (I) and each quadrature component (Q) by applying the selected control signals; and
based on the in-phase and quadrature components (IQ) measured by applying the control signals, select a control signal corresponding to an IQ measurement value close to a reference value.

2. The electronic device of claim 1, wherein at least one processor, individually and/or collectively, is configured to cause the electronic device to, based on the selected control signal, control the at least one antenna circuit to perform impedance matching of the antennas.

3. The electronic device of claim 2, wherein at least one processor, individually and/or collectively, is configured to cause the electronic device to periodically identify whether the network frequency is changed while a communication operation is performed using the impedance-matched antennas.

4. The electronic device of claim 3, wherein at least one processor, cause the electronic device to, in case that the network frequency is maintained, identify whether a change in the IQ measurement value of the selected control signal is larger than or equal to a configured change.

5. The electronic device of claim 4, wherein at least one processor, individually and/or collectively, is configured to cause the electronic device to, based on the change in the IQ measurement value of the selected control signal being larger than or equal to the configured change:
measure IQ of RF signals according to the classified control signals;
identify an RF signal having IQ close to the reference value among the measured IQ, and reselect a control signal corresponding to the measured RF signal; and
control the antenna circuit, based on the reselected control signal.

6. The electronic device of claim 3, wherein at least one processor, individually and/or collectively, is configured to cause the electronic device to, based on network frequency being changed, select passive gain information, based on the changed frequency and the RAT, and control the antenna circuit, based on the selected passive gain information.

7. The electronic device of claim 1, wherein each of the plurality of pieces of passive gain information corresponds to a signal for controlling at least one switch which connects the antennas with impedance included in the matching circuit.

8. The electronic device of claim 1, wherein at least one processor, individually and/or collectively, is configured to cause the electronic device to identify whether the RAT used by the electronic device is at least one of standalone (SA), non-standalone (NSA), and/or carrier aggregation.

9. The electronic device of claim 1, wherein at least one processor, individually and/or collectively, is configured to cause the electronic device to store, in the memory, the plurality of pieces of passive gain information as a lookup table converted in a code format.

10. The electronic device of claim 1, wherein at least one processor, individually and/or collectively, is configured to cause the electronic device to identify a value of combined average of passive gains of RF signals according to the selected control signals and sort the control signals in descending order.

11. A method of controlling antennas by an electronic device, the method comprising:
identifying a network frequency used by the electronic device;
identifying a radio access technology (RAT) used by the electronic device;
selecting control signals corresponding to passive gain information higher than or equal to a specified gain among a plurality of pieces of passive gain information corresponding to a plurality of control signals, based on the identified frequency and the identified RAT;
sorting and managing the selected control signals;
measuring each in-phase component (I) and each quadrature component (Q) by applying the selected control signals; and
based on the in-phase and quadrature components (IQ) measured by applying the control signals, selecting a control signal corresponding to an IQ measurement value close to a reference value.

12. The method of claim 11, further comprising controlling the at least one antenna circuit, based on the selected control signal.

13. The method of claim 12, further comprising periodically identifying whether the network frequency is changed while a communication operation is performed using the impedance-matched antennas.

14. The method of claim 13, further comprising, based on the network frequency being maintained, identifying whether a change in the IQ measurement value of the selected control signal is larger than or equal to a configured change.

15. The method of claim 14, comprising, based on the change in the IO measurement value of the selected control signal being larger than or equal to the configured change:
measuring IQ of RF signals according to the classified control signals;
identifying an RF signal having IQ close to standard impedance among the measured IQ, and reselecting a control signal corresponding to the measured RF signal; and
controlling the antenna circuit, based on the reselected control signal.

16. The method of claim 13, further comprising, based on the network frequency being changed, selecting passive gain information, based on the changed frequency and the RAT, and controlling the antenna circuit, based on the selected passive gain information.

17. The method of claim 11, wherein each of the plurality of pieces of passive gain information corresponds to a signal for controlling at least one switch which connects the antennas with impedance included in the matching circuit.

18. The method of claim 11, further comprising identifying whether the radio access technology (RAT) used by the electronic device is at least one of standalone (SA), non-standalone (NSA), and/or carrier aggregation.

19. The method of claim 11, further comprising storing, in the memory, the plurality of pieces of passive gain information as a lookup table converted in a code format.

20. The method of claim 11, further comprising identifying a values of combined average of passive gains of RF signals according to the selected passive gain information and sorting the passive gain information in descending order.
